(19) United States
(12) Patent Application Publication
(10) Pub. No.: US 2020/0179802 A1
(43) Pub. Date: Jun. 11, 2020

(54) A SYSTEM AND METHOD FOR IMPLEMENTING A COMPUTERIZED GAME

(71) Applicant: PLAYPROPERTIES ENTERTAINMENT LTD., TEL AVIV (IL)

(72) Inventor: Yaacov BARKI, Tel Aviv (IL)

(21) Appl. No.: 16/619,939

(22) PCT Filed: Jun. 12, 2018
(86) PCT No.: PCT/IL18/50641

§ 371 Date: Dec. 5, 2019

Related U.S. Application Data
(60) Provisional application No. 62/518,618, filed on Jun. 13, 2017.

(51) Int. Cl. A63F 13/35

(52) U.S. Cl. CPC A63F 13/35

(57) ABSTRACT

The subject matter discloses a computerized server for controlling an online game, comprising a gaming engine configured to run the online game, a communication interface configured to communicate game-related data between the gaming engine and an electronic device used by a player of the online game, a real-world data input configured to collect data concerning real world events, a gaming storage configured to store game elements of the online game, a conversion storage configured to store conversion functions, said conversion functions receive as input data concerning real world events and output updates of the game elements of the online game and a processing module configured to receive the data concerning real world events from the real-world data input and update at least one element of the game elements s of the online game according to the conversion rules.

### FIELD OF THE INVENTION

The present invention relates to computerized games in general, and to a method of managing computerized online games.

### BACKGROUND OF THE INVENTION

Online games are computerized games played by one or more players using an electronic device such as a smartphone or a tablet computer. The one or more players input commands into the electronic device, the commands are later sent to a gaming server managing the game.

Some online games are played for long period of times, for example weeks or months, where the players accumulate scores gradually.

Game mechanics are constructed of rules or methods designed for interaction with the game state, thus providing gameplay. The game mechanics and rules are commonly stored in a database included in or communicating with the gaming server. The rules dictate how players gain points or other valuable attributes such as tools, forces and the like. The game's rules are constant during the game, and the game mechanics may be influenced by the player's performance in the online game, for example gaining tools or changing visual background when reaching a new level in the online game. Most games are repetitive experiences for the players.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method of managing an online game according to data concerning real world events, according to exemplary embodiments of the present invention;

FIG. 2 shows a system of managing an online game according to data concerning real world events, according to exemplary embodiments of the present invention;

FIGS. 3A-3B show tables describing updates of game elements according to data concerning real world events, according to exemplary embodiments of the present invention; and,

FIG. 4 shows a computerized environment including physical sensors, the gaming server and client devices communicating with the gaming server, according to exemplary embodiments of the present invention.

### SUMMARY OF THE INVENTION

It is an object of the claimed subject matter to disclose a computerized server for controlling an online game, comprising a gaming engine configured to run the online game, a communication interface configured to communicate game-related data between the gaming engine and an electronic device used by a player of the online game, a real-world data input configured to collect data concerning real world events, a gaming storage configured to store game elements of the online game; a conversion storage configured to store conversion functions, said conversion functions receive as input data concerning real world events and output updates of the game elements of the online game; a processing module configured to receive the data concerning real world events from the real-world data input and update at least one element of the game elements s of the online game according to the conversion rules.

In some cases, the processing module is configured to update a game element representing a tool used by the player of the online game.

In some cases, the processing module is configured to update a game element representing a rule of the online game. In some cases, the processing module is configured to update a game element representing environmental data of the online game. In some cases, the real-world data input is electronically coupled to a data stream disclosing updates concerning the real world.

In some cases, the data stream is coupled to sensors located in a physical location associated with the online game, wherein information collected by the sensors is used as input of the conversion functions.

In some cases, the conversion function has a finite number of outputs for updating a game element stored by the gaming storage, and wherein the conversion function selects an update for the game element according to a range of values associated with the data concerning real world events. In some cases, the gaming storage comprises a finite number of options for at least a portion of the gaming elements. In some cases, the conversion function is configured to update a characteristic of a character used in the online game, according to performance of an entity associated with the character in the real world, as received via the real-world data input.

In some cases, the gaming storage stores a timing indicator associated with at least a portion of the game elements, wherein the game element is updated for a predefined period of time associated with the timing indicator, wherein the processing module queries the real-world data input after the predefined period of time lapses.

In some cases, the gaming storage stores a timing activator associated with at least a portion of the game elements, wherein the game element is updated after a predefined period of time lapses from collecting the data concerning real world events, said predefined period of time is associated with the timing activator.

In some cases, the server is configured to enable players to play multiple online games, wherein the server comprises a player interface via which the players select a game from the multiple online games, wherein the processing module changes a game played by the multiple players from the selected game to another game of the multiple online games according to the real-world data input.

In some cases, the server further comprises players storage module configured to store information related to players using the server, wherein the at least one of the conversion functions is configured to receive data from the players storage module as input when updating a game element in the gaming storage according to the information related to players using the server combined with the real-world data input.

In some cases, the at least one of the conversion functions is configured to receive a player's geographic location, correlate the player's geographic location with a location associated with the data concerning real world events and update the game element according to the data concerning real world events and the player's geographic location.

In some cases, the real-world data input is configured to collect information from one or more sensors located in physical locations, wherein at least one of the conversion functions receive the information from one or more sensors as input and updates a game element according to the information from one or more sensors.

### DETAILED DESCRIPTION OF THE INVENTION

The present invention discloses a system and method of managing a computerized game, for example an online game managed by a web server. The game can be played by a single player versus the gaming server, multiple players cooperating using different client devices and playing versus the server, or multiple players playing against each other. The system comprises a gaming server connected to a live data stream from the real world. The gaming server uses the data received via the live data stream to adjust a property of the online game. The live stream may contain live weather, live news, live stock exchange reports, political poles or election results, live sports results and events, live entertainment and other fields. The term “live” is defined as the occurrence of the event, or collection of the measurement, happened either during the game or a predefined duration prior to the game, for example 24 hours prior to the game. In some other embodiments, the term “live” is defined as the occurrence of the event, or collection of the measurement, happened either during the game.

The gaming server adjusts a game element of the online game according to a set of conversion functions configured to convert the data received from the live stream to changes in the game element. The game element may be a type or sub-type of the online game played via the server. For example, an online game in which the players compete at yacht sailing will be updated into windsurfing competition during the online game due to real world data indicating high waves in a real sea or ocean. In other cases, the game element may be a sub-type of a game, and the gaming server will update the online game from a first strategy game having specific characters or tools to a second strategy game excluding the specific characters. In other cases, the game element updated according to the live stream of the real world data may be characteristics, abilities of characters, features and tools used by the players, or a portion of the players. For example, if a character is known to be strong, fast or accurate, the character's strength may change. The gaming server may also adjust the environmental circumstances of the game according to the live stream data. For example, the game of basketball is played on mud or on a wet parquet floor when the live data indicates rain.

Adjusting the game element may consider personalized parameters associated with the players playing the online game, or consider properties of the online game. For example, the gaming server may obtain the geo-location of the players and adjust the game element according to the live stream concerning the players' locations. For example, only weather or news from the players' country is considered when the gaming server determines whether or not to adjust the gaming property. In some other cases, the gaming server may receive live stream concerning a satellite's location, and update a game element when the satellite is located over the player's country. In another case, the player plays a war game and uses a computerized tool during the online game, the tool's strength is updated when the satellite is located over the country the user wishes to conquer.

Adjusting the game element enables players to enjoy many more variations of the same game, without the players having the control of the game variations. This way, players' level of engagement to the game increases, which is one of the game's producer's targets.

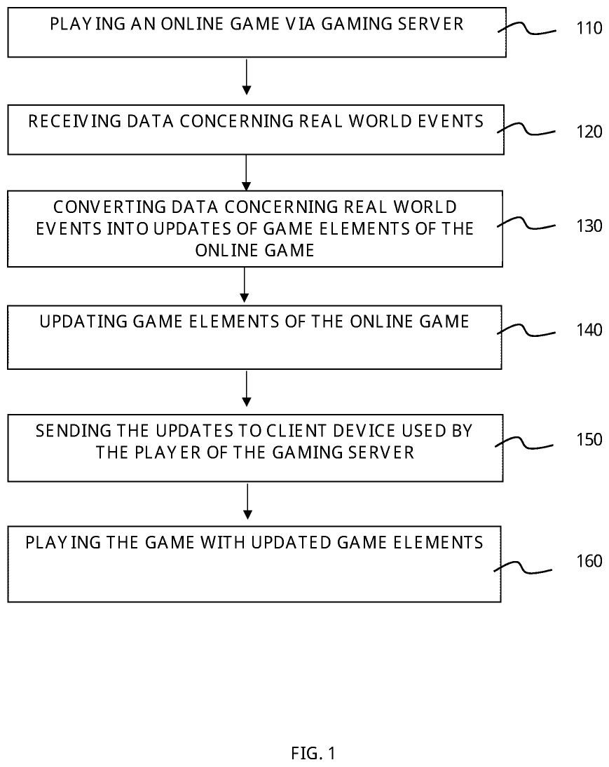

FIG. 1 shows a method of managing an online game according to data concerning real world events, according to exemplary embodiments of the present invention. Step 110 discloses playing an online game via the gaming server. The online game may be played by one player versus the server or by multiple players, one versus the other. The game is played according to the player or players' selection, for example game “A”, sub-type “3” and level “5”. The player or players input commands and/or data used by the gaming server to manage the game via the player's client device or devices, for example personal computers, laptop, tablet, cellular phones and the like.

Step 120 discloses the gaming server receiving data concerning real world events. Such data may be inputted manually by an operator of the gaming engine. In other cases, the data may be provided by a live data stream, for example a news channel, stock exchange data stream and the like. The data from the live data stream may be parsed by the gaming server or otherwise processed, for example by filtering the data. In some exemplary cases, the data is detected according to information stored in the conversion storage. For example, the conversion storage comprises a finite set of conversion functions, and only when the data received in the gaming server matches one or more of the conversion functions, the data is transferred to the processing module of the gaming server.

Step 130 discloses converting data concerning real world events into updates of properties of the online game. The real data events may be converted according to a predefined set of conversion rules stored in the gaming server. The conversion rules may be adjusted periodically. The conversion rules define conditions in which the game properties are updated. For example, in case the weather in a real world area changes, change a game property. Updating the game property may comprise addition, removal or change of a game element such as tools or characters. In some other examples, the online game utilizes cards or tools represented by an animal such as a dolphin. When the live data stream comprises indication of a storm, the card or tool with the dolphin is assigned higher rank and therapeutic capabilities that can be used during the game. Assigning the rank may be performed by updating a data field in the gaming storage, or by selecting a value to be used for a game element from multiple optional values. For example selecting a value 8 for speed, from an array of values from 1 to 10.

In some exemplary cases, characteristics of a real world event may be used to update the game element. Such characteristic may be a sound volume in a match or riot, number of spectators in a rock concert, TV rating of an event, and the like. Converting the real world data may be performed according to the game played. For example, in case the real world event relates to weather in Africa, such information will only be relevant to an online game of car racing. When the real world data is sand storm, the game element updated is the vehicle's performance. For example, activating or deactivating abilities of the vehicle such as rear camera.

Step 140 discloses updating game elements of the online game. Such updates are performed by the processing module of the gaming server and stored in the gaming storage. The game elements may be updated for a limited period of time, for example 10 seconds, until the end of the specific game, until a data concerning real world event dictates another update of the same game element. In some cases, multiple players play the same game at the same time and updates to the game elements may be applied only to a portion of the multiple players, according to the set of conversion functions and rules to apply the conversion functions. The update of the game element may consider players information as stored in a player storage of the gaming server, for example players' age, gender, location, playing history, previous purchases in the gaming server and the like. The player's information may be concluded into a player value and the conversion may consider the player's information when determining how to convert the game element that effects the player's experience.

Step 150 discloses sending the updates of the game element to client devices used by the players of the gaming server. In some exemplary cases, the updates of the game element are kept in the gaming storage, for example a characteristic of a tool used by the player, without updating in the player's device. The updates may be sent as images, audio files, commands, executable files and the like. Step 160 discloses playing the game with updated game elements.

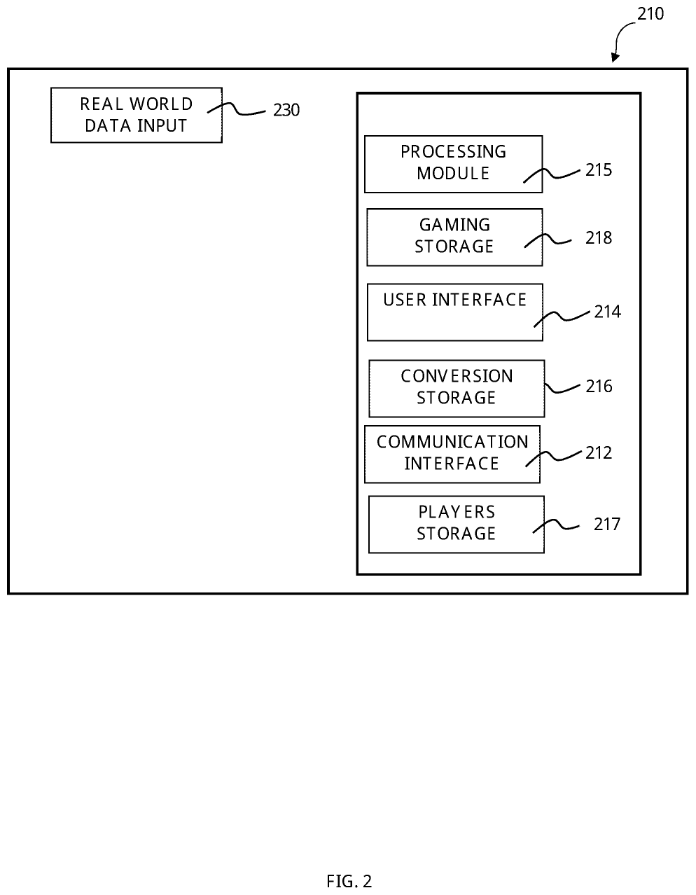

FIG. 2 shows a system of managing an online game according to data concerning real world events, according to exemplary embodiments of the present invention.

The system 210 comprises a gaming server 210 that manages online games played by one or more players. A single gaming server 210 may offer multiple games, in one or more gaming categories, levels, visual background and the like, according to the players' selection. The gaming server 210 stores information about the one or more games suggested to players at the gaming storage 218. Such information may be game mechanics, game characters, audio files, image files, game rules, records and the like. The gaming server 210 may further comprise a players storage 217 configured to store information about the players. Such information may be players' age, gender, and geographic location, device type used by the player, financial transactions performed by the player on the gaming server 210 and others.

The gaming server 210 comprises a communication interface 212 for communicating with the client devices operated by the players. The gaming server 210 comprises a processing module 215 configured to manage the process of updating the game elements according to information received via the real world data input 230. The real world data input 230 may be an information channel receiving information from one or more resources, such as stock exchange news, weather channel, sports channel, entertainment channel and the like. The processing module 215 collects at least a portion of the information received via the real world data input 230 and converts the real world information into updates to the game elements. Such conversion is performed according to conversion functions stored in the conversion storage 216, said conversion functions receive as input the data concerning real world events and output updates of the game elements of the online game. Such updates may be to select a visual background of the game from a finite number of optional backgrounds according to data concerning real world events. In some other cases, the update may be to increase a strength, speed or another characteristic of an object used in the game. The update of the game element may be immediate after received at the processing module, or a predefined period of time afterwards. The update may be permanent, for example until the end of the game, or temporal, as elaborated below. The updates are stored in the gaming storage, for example by updating a data field or by updating that a characteristic is represented by option #3 instead of option #1.

The game may be selected by the players using a player interface 215.

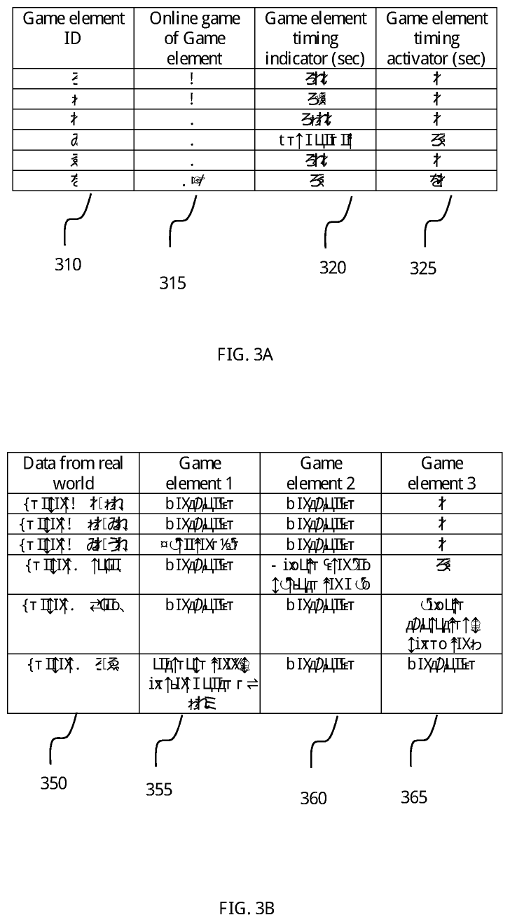

FIGS. 3A-3B show tables describing updates of game elements according to data concerning real world events, according to exemplary embodiments of the present invention. The tables are exemplary representations of data structures for storing the information about the game elements and the way the game elements are updated. Updating may be implemented by adding, removing, adjusting, activating, deactivating elements in the online game that change the way players consume the game. The game element in not the game's result or score.

FIG. 3A shows game elements 310 sorted according to their identifiers. In the table, there are six (6) different game elements 310, each of the game elements 310 has an online game in which the game element is relevant. In some cases, the table only shows the games 315 in which the game elements 310 are updated. For example, game element #2 may be used in games A, B and C, and only updated in response to real world events when the players play game A. The table also shows game element timing indicator 320 and game element timing activator 325. The game element timing indicator 320 defines the time duration in which the game element is updated. The game element timing activator 325 defines the time duration lapsing between processing the update required for a game element and actual update of the element.

FIG. 3B shows a table representing information concerning actual update of the game elements. For example, the first row 350 comprises multiple distinct inputs from the real world. Such inputs may be from the live stream, from sensors and the like. The input may be processed to identify how to process the input, for example whether the input from the sensor is in the range of 20 to 40 or in the range of 40 to 80. Each input 350 is associated with one or more game elements 355, 360, 365. It can be seen that in many cases, the input does not result in updating the game elements. The update may be visual, update the visual to blue, or update a numeric value to 15, increase performance relative to prior performance and the like.

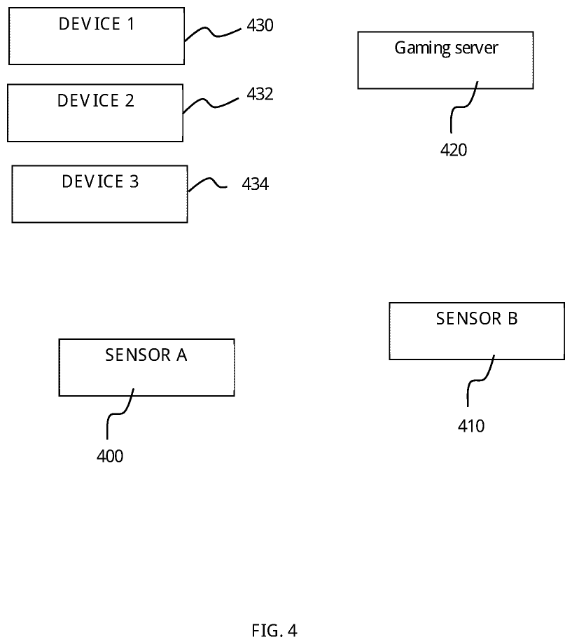

FIG. 4 shows a computerized environment including physical sensors, the gaming server and client devices communicating with the gaming server, according to exemplary embodiments of the present invention. The computerized environment comprises multiple client devices 430, 432 and 434 used by players of the gaming server 420. The client devices 430, 432 and 434 may communicate with the gaming server 420 via a browser or a dedicated software application operating on the client devices 430, 432 and 434. The client devices 430, 432 and 434 may any electronic device with communication capabilities, input device and display device, such as telephone devices, tablets, laptops, personal computers, and the like. The client devices 430, 432 and 434 may communicate with the gaming server 420 via the internet or via a local network.

The computerized environment comprises one or more sensors 400, 410 located in physical locations. In some cases, the sensors 400, 410 may be located in distinct locations, for example in different residents, or different countries. The sensors 400, 410 may measure temperature, air quality, presence of materials in the air, noise, capture images and the like. The sensors may have communication capabilities configured to send signals to a remote device, such signals are configured to be received at the gaming server 420, for example via a cellular network or via the internet. Information from the sensors 400, 410 may be used by the gaming server 420 when updating game elements of the online game. For example, noise in a place where the sensor 400 is located may be converted to increasing a noise in an online game associated with the location of the sensor 400. For example, in case the sensor 410 is installed on a mobile boat, the sensor may measure the waves' movement and the gaming server 420 may convert the movement detected by the sensor 410 into movement of a person in a running game.

In some exemplary cases, the subject matter discloses a server coupled to one or more electronic devices. Players of a physical game operate the one or more electronic devices, such as telephones, tablet computers and laptops, in order to receive communication from the server. The server receives details of the physical game from the one or more players, and has the functionalities of the gaming server disclosed above, excluding the gaming engine, as the one or more players manage the physical game themselves. The server receives data concerning real world events via the real-world data input and converts the data concerning real world events into changes to game elements of the physical game using the processing module and the conversion module. Then, the changes to the game elements of the physical game are sent to at least a portion of the one or more electronic devices used by the players of the physical game. The changes may then be displayed on all the electronic devices used by the players of the physical game or only displayed on the electronic devices used by the players that are relevant to the change of the game element.

For example, five players playing a physical card game, as cards have different characteristics, such as abilities, forces and the like. The cards and the cards' characteristics are stored in the server as game elements, which are updated according to data concerning real world events. The cards' characteristics are updated frequently according to weather changes as received at the server. The changes are sent from the server to the electronic devices used by the players while playing the physical card game.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

We claim

1. A computerized server for controlling an online game, comprising:
a gaming engine configured to run the online game;
a communication interface configured to communicate game-related data between the gaming engine and an electronic device used by a player of the online game;
a real-world data input configured to collect data concerning real world events;
a gaming storage configured to store game elements of the online game;
a conversion storage configured to store conversion functions, said conversion functions receive as input data concerning real world events and output updates of the game elements of the online game;
a processing module configured to receive the data concerning real world events from the real-world data input and update at least one element of the game elements of the online game according to the conversion rules.

2. The server of claim 1, wherein the processing module is configured to update a game element representing a tool used by the player of the online game.

3. The server of claim I, wherein the processing module is configured to update a game element representing a rule of the online game.

4. The server of claim 1, wherein the processing module is configured to update a game element representing environmental data of the online game.

5. The server of claim 1, wherein the real-world data input is electronically coupled to a data stream disclosing updates concerning the real world,

6. The server of claim 5, wherein the data stream is coupled to sensors located in a physical location associated with the online game, wherein information collected by the sensors is used as input of the conversion functions.

7. The server of claim 1, wherein the conversion function has a finite number of outputs for updating a game element stored by the gaming storage, and wherein the conversion function selects an update for the game element according to a range of values associated with the data concerning real world events.

8. The server of claim 1, wherein the gaming storage comprises a finite number of options for at least a portion of the gaming elements.

9. The server of claim 1, wherein the conversion function is configured to update a characteristic of a character used in the online game, according to performance of an entity associated with the character in the real world, as received via the real-world data input.

10. The server of claim 1, wherein the gaming storage stores a timing indicator associated with at least a portion of the game elements, wherein the game element is updated for a predefined period of time associated with the timing indicator, wherein the processing module queries the real-world data input after the predefined period of time lapses.

11. The server of claim 1, wherein the gaming storage stores a timing activator associated with at least a portion of the game elements, wherein the game element is updated after a predefined period of time lapses from collecting the data concerning real world events, said predefined period of time is associated with the timing activator.

12. The server of claim 1, wherein the server is configured to enable players to play multiple online games, wherein the server comprises a player interface via which the players select a game from the multiple online games, wherein the processing module changes a game played by the multiple players from the selected game to another game of the multiple online games according to the real-world data input.

13. The server of claim 1, further comprises players storage module configured to store information related to players using the server, wherein the at least one of the conversion functions is configured to receive data from the players storage module as input when updating a game element in the gaming storage according to the information related to players using the server combined with the real-world data input.

14. The server of claim 1, wherein the at least one of the conversion functions is configured to receive a player's geographic location, correlate the player's geographic location with a location associated with the data concerning real world events and update the game element according to the data concerning real world events and the player's geographic location.

15. The server of claim 1, wherein the real-world data input is configured to collect information from one or more sensors located in physical locations, wherein at least one of the conversion functions receive the information from one or more sensors as input and updates a game element according to the information from one or more sensors.

16. A computerized system for managing a physical game, comprising:
a sever, comprising:
a communication module configured to communicate with multiple electronic devices;
a real-world data input configured to collect data concerning real world events; a gaming storage configured to store game elements of the physical game;
a conversion storage configured to store conversion functions, said conversion functions receive as input data concerning real world events and output updates of the game elements of the physical game;
a processing module configured to receive the data concerning real world events from the real-world data input and update at least one element of the game elements of the online game according to the conversion rules;
multiple computerized elements, each of which is stored at an electronic device communicating with the server, wherein players of the physical game play the game according to changes of the game elements received from the server.

17. The computerized server according to claim 1 wherein the data concerning real world events is related to events that are not player specific.

18. A method for controlling an online game, comprising:
running, by a gaming engine, the online game;
communicating, by a communication interface, game-related data between the gaming engine and an electronic device used by a player of the online game;
collecting, by a real-world data input, data concerning real world events;
storing, by a gaming storage, game elements of the online game;
string, by a conversion storage, conversion functions, said conversion functions receive as input data concerning real world events and output updates of the game elements of the online game;
receiving, by a processing module, the data concerning real world events from the real-world data input; and
updating, by the processing module, at least one element of the game elements of the online game according to the conversion rules.

19. The method according to claim 18 wherein the data concerning real world events is related to weather conditions.

20. The method according to claim 18 wherein the data concerning real world events is related a stock exchange.

21. The method according to claim 18 wherein the data concerning real world events is related to sport or entertainment events.
